(19) United States
(12) Patent Application Publication
(10) Pub. No.: US 2017/0152817 A1
(43) Pub. Date: Jun. 1, 2017

(54) Air Cleaner And Air Cleaner Manufacturing Method

(71) Applicant: Wako Filter Technology Co., Ltd., Tokyo (JP)

(72) Inventor: Naoto Kikuchi, Fukuroi-shi (JP)

(21) Appl. No.: 15/336,188

(22) Filed: Oct. 27, 2016

(30) Foreign Application Priority Data
Nov. 26, 2015 (JP) 2015-231089

(51) Int. Cl. F02M 35/02; B01D 46/16; B01D 46/00

(52) U.S. Cl. CPC F02M 35/0215; B01D 46/002; B01D 46/16; B01D 46/0001; F02M 35/0203; B01D 2271/022; B01D 2279/60; B01D 2265/05

(57) ABSTRACT

First protuberance of a squared-U-shaped frame in one case and second protuberance of a squared-U-shaped frame in other case contact each other, and the one case and the other case are joined together through a method such as vibration welding and/or the like. Furthermore, a gasket is positioned at a position contacting the end of the first protuberance and the end of the second protuberance, and also positioned so as to surround an intake opening, and is jointed to a flank in the one case and a flank in the other case.

### CROSS-REFERENCE TO RELATED APPLICATION

This application claims the benefit of Japanese Patent Application No. 2015-231089, filed on Nov. 26, 2015, the entire disclosure of which is incorporated by reference herein.

### FIELD OF THE INVENTION

This application relates generally to an air cleaner and an air cleaner manufacturing method.

### BACKGROUND OF THE INVENTION

Conventionally, an air cleaner has been used in a vehicle and/or the like in order to remove dust and/or the like mixed with air supplied to the vehicle's engine (for example, see Unexamined Japanese Patent Application Kokai Publication No. 2015-121165). This kind of air cleaner is such that a path for air is formed from an opening to a filter. Air that has entered from the opening flows to the outside after dust and/or the like has been removed by the filter.

In the above-described air cleaner, the ideal is for air flowing to the outside to all be air that has passed through a filter, in order to increase the purity of the air. Consequently, improving airtightness of the air cleaner is necessary.

In consideration of the foregoing, an objective of the present disclosure is to improve airtightness.

### SUMMARY OF THE INVENTION

In order to achieve the above objective, an air cleaner according to a first aspect of the present disclosure is an air cleaner comprising a first box-shaped member and a second box-shaped member, and a joining member for joining the first box-shaped member and the second-box shaped member, wherein:

the first box-shaped member comprises:
a rectangular first filter;
four first flanks joined to and rising over outer edges of the first filter;
a first notch formed in one first flank, out of the first flanks, and in a side facing the side to which the first filter is joined; and
of the first flanks, a first protrusion is formed in the first flank in which the first notch is not formed, along a side opposite the side to which the first filter is joined; and

the second box-shaped member comprises:
a rectangular second filter;
four second flanks joined to and rising over outer edges of the second filter; and
a second notch formed in one second flank, out of the second flanks, and in a side facing the side to which the second filter is joined;
of the second flanks, a second protrusion is formed in the second flank in which the second notch is not formed, along a side opposite the side to which the second filter is joined;

the first box-shaped member and the second box-shaped member are joined such that the first protrusion and the second protrusion face each other, and the first notch and the second notch face each other; and

the joining member covers the end of the first protrusion and the end of the second protrusion.

The joining member may be ring-shaped.

The joining member may be adhered to the outer edge of the first flank on which the first notch is formed, out of the first flanks, and to the outer edge of the second flank on which the second notch is formed, out of the second flanks.

The first box-shaped member and the second box-shaped member may have the same shape.

In order to achieve the above objective, a method of manufacturing an air cleaner according to a second aspect of the present disclosure is a method of manufacturing an air cleaner comprising a first box-shaped member and a second box-shaped member, and a joining member for joining the first box-shaped member and the second-box shaped member, wherein:

the first box-shaped member comprises:
a rectangular first filter;
four first flanks joined to and rising over outer edges of the first filter;
a first notch formed in one first flank, out of the first flanks, and in a side facing the side to which the first filter is joined; and
of the first flanks, a first protrusion is formed in the first flank in which the first notch is not formed, along a side opposite the side to which the first filter is joined; and

the second box-shaped member comprises:
a rectangular second filter;
four second flanks joined to and rising over outer edges of the second filter; and
a second notch formed in one second flank, out of the second flanks, and in a side facing the side to which the second filter is joined;
of the second flanks, a second protrusion is formed in the second flank in which the second notch is not formed, along a side opposite the side to which the second filter is joined; and

the method includes a joining step for joining the first box-shaped member and the second box-shaped member such that the first protrusion and the second protrusion face each other, and the first notch and the second notch face each other; and

a cover step for covering the end of the first protrusion and the end of the second protrusion with the joining member.

The joining step may be accomplished by vibration welding.

With the present disclosure improvement in airtightness is possible.

### BRIEF DESCRIPTION OF THE DRAWINGS

A more complete understanding of this application can be obtained when the following detailed description is considered in conjunction with the following drawings, in which:

FIG. 1 is an external oblique view of components comprising an air cleaner according to an exemplary embodiment;

FIG. 2 is an external oblique view of the air cleaner according to the exemplary embodiment;

FIG. 3 is an enlarged view of a joint location in the air cleaner according to the exemplary embodiment;

FIG. 4 is an external oblique view of components comprising an air cleaner unit according to the exemplary embodiment; and

FIG. 5 is an external oblique view of the air cleaner unit according to the exemplary embodiment.

### DETAILED DESCRIPTION OF THE INVENTION

Below, an exemplary embodiment of the present disclosure is described in detail with reference to the drawings.

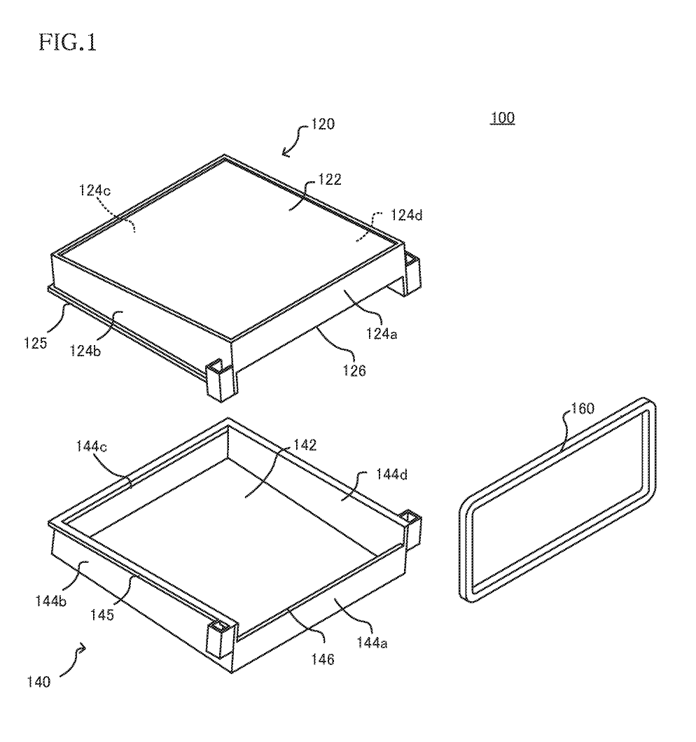

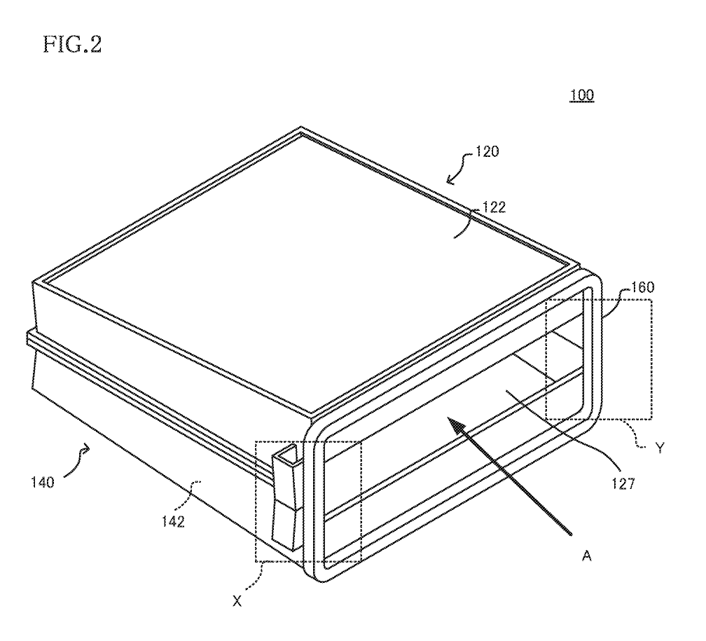

FIG. 1 is an external oblique view of components comprising an air cleaner according to the exemplary embodiment, and FIG. 2 is an external oblique view of the air cleaner according to the exemplary embodiment. As shown in FIG. 1 and FIG. 2, an air cleaner 100 includes a case 120 as a first box-shaped member, a case 140 as a second box-shaped member and a gasket 160 as a joining member.

The case 120 includes a filter 122; flanks 124a, 124b, 124c and 124d as first flanks; and a squared-U-shaped frame 125.

The filter 122 is rectangular and sheet-shaped, and is made of a sheet and/or the like of glass fibers, foam materials such as sponge and/or the like, nonwoven cloth, paper such as filter paper and/or the like and granular activated charcoal woven together. The surface of the filter 122 is formed in a saw-toothed or wavelike shape of a prescribed pitch.

The flanks 124a, 124b, 124c and 124d as first flanks are made of resin and/or the like. One side of the flanks 124a, 124b, 124c and 124d is joined to the four sides of the filter 122 in this order. In addition, of the two sides in the flank 124a that connect to both ends of the side joining the filter 122, one is joined to the flank 124b and the other is joined to the flank 124d. Of the two sides in the flank 124b that connect to both ends of the side joining the filter 122, one is joined to the flank 124a and the other is joined to the flank 124c. Of the two sides in the flank 124c that connect to both ends of the side joining the filter 122, one is joined to the flank 124b and the other is joined to the flank 124d. Of the two sides in the flank 124d that connect to both ends of the side joining the filter 122, one is joined to the flank 124a and the other is joined to the flank 124c. As described above, a box-shaped member is formed by the filter 122 and the flanks 124a, 124b, 124c and 124d being joined together.

In the flank 124a, on the side of the side opposite the side connected with the filter 122, a notch 126 is formed as a first notch. In addition, the squared-U-shaped frame 125 is joined to the sides of the flanks 124b, 124c and 124d, opposite the sides joined to the filter 122. The squared-U-shaped frame 125, like the flank 124a, is made of resin and/or the like. In addition, the respective sides of the flanks 124b and 124d joining the flank 124a are longer than the sides joining the flank 124c.

The case 140 has the same shape as the case 120. The case 140 includes a filter 142; flanks 144a, 144b, 144c and 144d as second flanks; and a squared-U-shaped frame 145.

The filter 142, like the filter 122, is rectangular and sheet-shaped, and is made of a sheet and/or the like of glass fibers, foam materials such as sponge and/or the like, nonwoven cloth, paper such as filter paper and/or the like and granular activated charcoal woven together. The surface of the filter 142 is formed in a saw-toothed or wavelike shape of a prescribed pitch.

The flanks 144a, 144b, 144c and 144d as second flanks are made of resin and/or the like. One side of the flanks 144a, 144b, 144c and 144d is joined to the four sides of the filter 142 in this order. In addition, of the two sides in the flank 144a that connect to both ends of the side joining the filter 142, one is joined to the flank 144b and the other is joined to the flank 144d. Of the two sides in the flank 144b that connect to both ends of the side joining the filter 142, one is joined to the flank 144a and the other is joined to the flank 144c. Of the two sides in the flank 144c that connect to both ends of the side joining the filter 142, one is joined to the flank 144b and the other is joined to the flank 144d. Of the two sides in the flank 144d that connect to both ends of the side joining the filter 142, one is joined to the flank 144a and the other is joined to the flank 144c. As described above, a box-shaped member is formed by the filter 142 and the flanks 144a, 144b, 144c and 144d being joined together.

In the flank 144a, on the side of the side opposite the side connected with the filter 142, a notch 146 is formed as a second notch. In addition, the squared-U-shaped frame 145 is joined to the sides of the flanks 144b, 144c and 144d opposite the sides joined to the filter 142. The squared-U-shaped frame 145, like the flank 144a, is made of resin and/or the like. In addition, the respective sides of the flanks 144b and 144d joining the flank 144a are longer than the sides joining the flank 144c.

In the process of manufacturing the air cleaner 100, the case 120 is positioned so that the filter 122 becomes the top surface, and the case 140 is positioned so that the filter 142 becomes the bottom surface. In addition, the case 120 and the case 140 are positioned so that the notch 126 in the case 120 and the notch 146 in the case 140 are opposite each other.

Furthermore, the squared-U-shaped frame 125 in the case 120 and the squared-U-shaped frame 145 in the case 140 touch each other, and the case 120 and the case 140 are joined together through a method such as vibration welding and/or the like. Through this, the notch 126 in the case 120 and the notch 146 in the case 140 are unified, so that an intake opening 127 for air is formed as shown in FIG. 2.

Following this, the gasket 160 is joined to the flank 124a in the case 120 and the flank 144a in the case 140 so as to surround the intake opening 127. The gasket 160 is a ring-shaped member made for example of rubber.

When air is cleaned by the air cleaner 100, as shown in FIG. 2 the air passes through the intake opening 127 from the direction of A and is taken into the air cleaner 100. The air that has been taken to the inside of the air cleaner 100 has dust and/or the like removed therefrom by the upper and lower filters 122 and 142. Furthermore, the air from which dust and/or the like has been removed flows to the outside of the air cleaner 100 from the top surface of the filter 122 and the bottom surface of the filter 142.

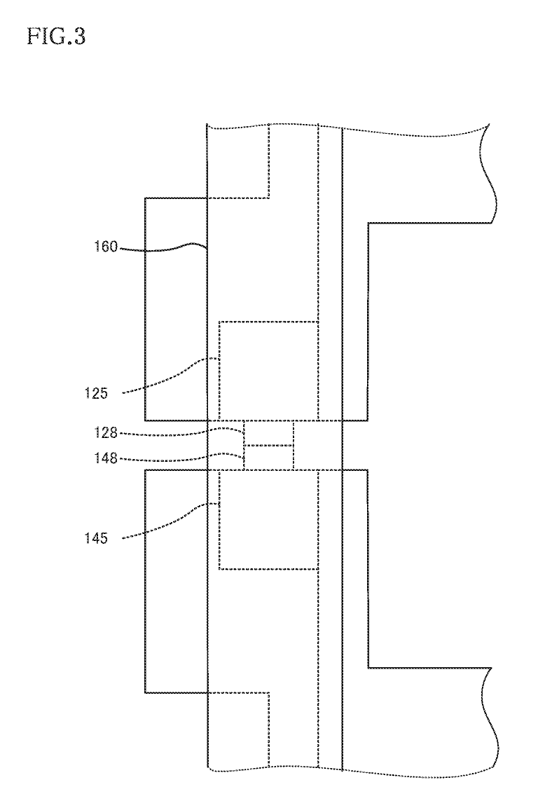

FIG. 3 is an enlarged view of a joint location between the case 120 and the case 140 in the air cleaner 100 according to the exemplary embodiment. FIG. 3 is an enlarged view of an X section as seen from the A direction in FIG. 2.

As shown in FIG. 3, a protuberance 128 is formed as a first protrusion in the bottom surface of the squared-U-shaped frame 125 in the case 120. On the other hand, a protuberance 148 is formed as a second protrusion in the top surface of the squared-U-shaped frame 145 in the case 140. When the case 120 and the case 140 are joined together, the protuberance 128 and the protuberance 148 touch each other and are fastened together through a method such as vibration welding and/or the like.

FIG. 3 shows the X section in FIG. 2, but similarly, in the Y section in FIG. 2 also, the protuberance 128 is formed as a first protrusion on the bottom surface of the squared-U-shaped frame 125 in the case 120, the protuberance 148 is formed as a second protrusion in the top surface of the squared-U-shaped frame 145 in the case 140, and furthermore, when the case 120 and the case 140 are jointed together, the protuberance 128 and the protuberance 148 touch each other and are fastened together through a method such as vibration welding and/or the like.

Furthermore, the gasket 160 is positioned at a position in contact with the end of the protuberance 128 and the end of the protuberance 148 and is adhered to the end of the protuberance 128 and the end of the protuberance 148, and is also joined together with the flank 124a in the case 120 and the flank 144a in the case 140.

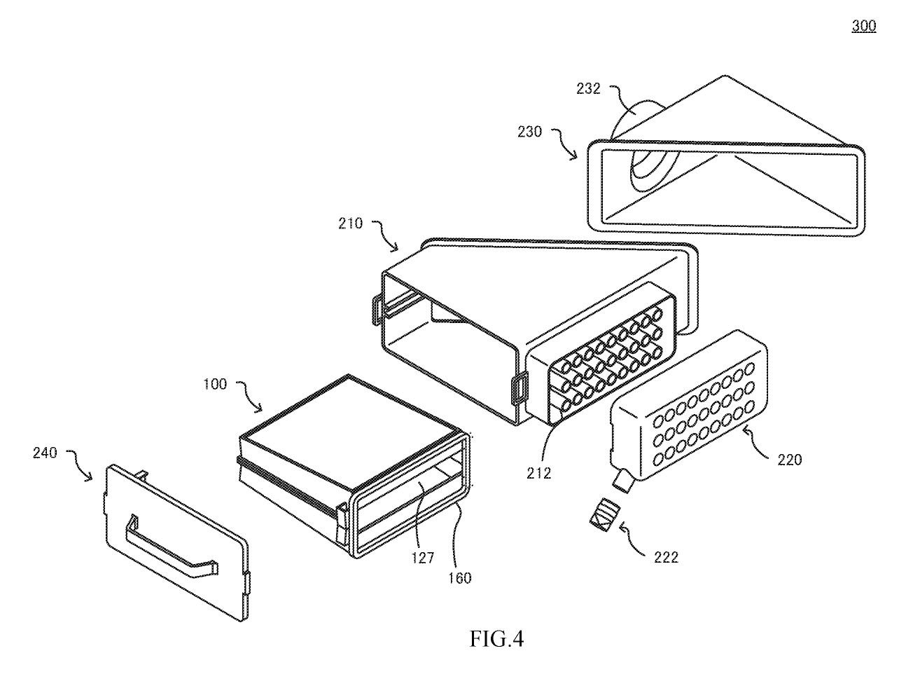

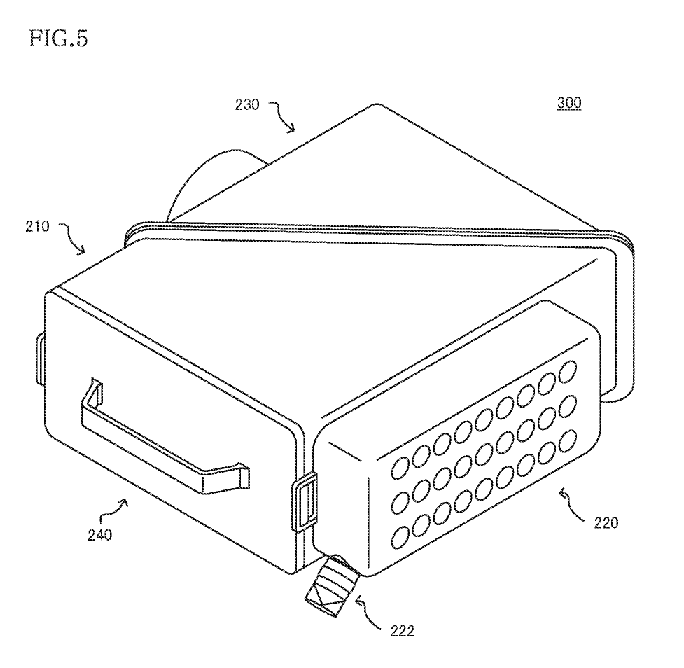

FIG. 4 is an external oblique view of components comprising an air cleaner unit 300 according to the exemplary embodiment, and FIG. 5 is an external oblique view of the air cleaner unit 300 according to the exemplary embodiment.

As shown in FIG. 4, the air cleaner unit 300 includes the air cleaner 100, an intake opening side case 210, an intake opening unit 220, a valve 222, an outflow opening side case 230 and a lid 240.

A fitting 212 is provided on the intake opening side case 210, and the intake opening unit 220 is mounted on the fitting 212. In addition, the valve 222 is provided on the intake opening unit 220. Furthermore, an exhaust opening 232 is provided in the outflow opening side case 230.

The air cleaner 100 is housed in the intake opening side case 210 and the outflow opening side case 230. At this time, the air cleaner 100 is positioned with the side on which the intake opening 127 is formed on the side of the fitting 212 of the intake opening side case 210, and the gasket 160 is adhered to the fitting 212. In addition, the air cleaner 100 is positioned such that the side opposite the side in which the intake opening 127 is formed is on the side of the exhaust opening 232 of the outflow opening side case 230.

Furthermore, in the intake opening side case 210, the lid 240 is mounted on the side opposite the side of the outflow opening side case 230. Through this, the air cleaner unit 300 is comprised as shown in FIG. 8. A worker can remove and exchange and/or the like the air cleaner 100 housed in the unit by opening the lid 240.

As described above, in the air cleaner 100 according to this exemplary embodiment, the case 120 is positioned so as to be above the filter 122 and the case 140 is positioned so as to be below the filter 142, and the notch 126 in the case 120 and the notch 146 in the case 140 are positioned so as to face each other. In addition, the protuberance 128 of the squared-U-shaped frame 125 in the case 120 and the protuberance 148 of the squared-U-shaped frame 145 in the case 140 contact each other, and the case 120 and the case 140 are jointed together through a method such as vibration welding and/or the like. The gasket 160 is positioned at a position in contact with the end of the protuberance 128 and the end of the protuberance 148 and is joined the flank 124a in the case 120 and the flank 144a in the case 140.

In this manner, the gasket 160 is positioned at a position in contact with the end of the protuberance 128 and the end of the protuberance 148 that have become integrated through vibration welding and is adhered to the end of the protuberance 128 and the end of the protuberance 148, and through this air taken into the air cleaner 100 from the intake opening 127 is prevented from leaking to the outside from around the end of the protuberance 128 and the end of the protuberance 148, and can only flow to the outside from the filter 122 and the filter 142. That is to say, the airtightness inside the air cleaner 100 improves, so the degree of cleaning of the air can be increased.

In addition, by making the gasket 160 ring-shaped, a single gasket 160 can be positioned at a position in contact with the end of the protuberance 128 and the end of the protuberance 148 in both the X and Y sections of FIG. 2, so simplifying manufacturing procedures becomes possible.

In addition, the case 120 and the case 140 have the same shape, so reducing cost and simplifying manufacturing procedures becomes possible because preparing respective molds for each is not necessary.

Although the exemplary embodiment was described above, the present disclosure is not limited to the above-described exemplary embodiment.

For example, the gasket 160 is not limited to a rubber member but may be a foam material such as a sponge and/or the like, for example. In addition, the gasket 160 may interlock with the end of the protuberance 128 and the end of the protuberance 148, and may be adhered thereto by an adhesive. In addition, the gasket 160 is not limited to a ring-shaped member, and for example may be such that a ring-shaped member is formed by joining together the ends of a string-shaped member. In addition, in place of the gasket 160, a member may be used that is positioned at a position in contact with the end of the protuberance 128 and the end of the protuberance 148 and that is sealed to end of the protuberance 128 and the end of the protuberance 148.

In addition, the case 120 and the case 140 need not have the same shape, and for example, the shapes of the case 120 and the case 140 may differ and one may interlock with the other.

Various embodiments and variations of the present disclosure are possible without deviating from the scope or broader application thereof. The above-described exemplary embodiment is for describing the present disclosure and does not limit the scope of the present disclosure.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An air cleaner comprising a first box-shaped member and a second box-shaped member, and a joining member for joining the first box-shaped member and the second-box shaped member, wherein:
the first box-shaped member comprises:
a rectangular first filter;
four first flanks joined to and rising over outer edges of the first filter;
a first notch formed in one first flank, out of the first flanks, and in a side facing the side to which the first filter is joined; and
of the first flanks, a first protrusion is formed in the first flank in which the first notch is not formed, along a side opposite the side to which the first filter is joined; and
the second box-shaped member comprises:
a rectangular second filter;
four second flanks joined to and rising over outer edges of the second filter; and
a second notch formed in one second flank, out of the second flanks, and in a side facing the side to which the second filter is joined;
of the second flanks, a second protrusion is formed in the second flank in which the second notch is not formed, along a side opposite the side to which the second filter is joined;
the first box-shaped member and the second box-shaped member are joined such that the first protrusion and the second protrusion face each other, and the first notch and the second notch face each other; and
the joining member covers the end of the first protrusion and the end of the second protrusion.

2. The air cleaner according to claim 1, wherein the joining member is ring-shaped.

3. The air cleaner according to claim 2, wherein the joining member is adhered to the outer edge of the first flank on which the first notch is formed, out of the first flanks, and to the outer edge of the second flank on which the second notch is formed, out of the second flanks.

4. The air cleaner according to claim 1, wherein the first box-shaped member and the second box-shaped member have the same shape.

5. A method of manufacturing an air cleaner comprising a first box-shaped member and a second box-shaped member, and a joining member for joining the first box-shaped member and the second-box shaped member, wherein:
the first box-shaped member comprises:
a rectangular first filter;
four first flanks joined to and rising over outer edges of the first filter;
a first notch formed in one first flank, out of the first flanks, and in a side facing the side to which the first filter is joined; and
of the first flanks, a first protrusion is formed in the first flank in which the first notch is not formed, along a side opposite the side to which the first filter is joined; and
the second box-shaped member comprises:
a rectangular second filter;
four second flanks joined to and rising over outer edges of the second filter; and
a second notch formed in one second flank, out of the second flanks, and in a side facing the side to which the second filter is joined;
of the second flanks, a second protrusion is formed in the second flank in which the second notch is not formed, along a side opposite the side to which the second filter is joined; and
the method includes a joining step for joining the first box-shaped member and the second box-shaped member such that the first protrusion and the second protrusion face each other, and the first notch and the second notch face each other; and
a cover step for covering the end of the first protrusion and the end of the second protrusion with the joining member.

6. The method of manufacturing an air cleaner according to claim 5, wherein the joining step is accomplished by vibration welding.
